(19) United States
(12) Patent Application Publication
(10) Pub. No.: US 2011/0178761 A1
(43) Pub. Date: Jul. 21, 2011

(54) Pattern For Identifying A Location On A Surface

(76) Inventors: Jose Maria Rodriguez Arnaldos, Fortuna Murcia (ES); Manuel Gonzalez, Malaga LLG (ES)

(21) Appl. No.: 12/919,202

(22) PCT Filed: Jan. 29, 2009
(86) PCT No.: PCT/EP2009/051022

§ 371 Date: Mar. 29, 2011

(30) Foreign Application Priority Data
Jan. 29, 2008 (GB) 0801575.2

(51) Int. Cl. G06F 15/00

(52) U.S. Cl. 702/150

(57) ABSTRACT

Provided is a method (400) for determining a location on a surface (200) from an image of a region of said surface, said surface being divided into a plurality of cells (302; 304) arranged in a first direction and a second direction perpendicular to said first direction, each cell comprising a plurality of marks (202; 204; 206; 208), forming a pattern which uniquely identifies a cell, the method comprising:
determining at least part of a boundary of a first cell from locations where marks of said plurality of marks are adjacent in with said first direction or said second direction (402);
determining a location of said first cell from said pattern in said first cell (404).

### BACKGROUND

Various methods exist for indicating positions for input into a data processing systems. For example a mouse may be used by a computer user to move a cursor around on a screen and indicate positions on the screen. A mouse cannot however indicate an absolute position; the position indicated by a mouse is based on the movements of the mouse over for example a mouse pad.

A method of determining an absolute position is to dispose a pattern on a surface and to include an imaging means in a pointing device. The image obtained of a portion of the pattern by the imaging device may be used to determine the location of the pointing device on the surface. When designing a pattern for disposing on such a surface, a trade off must be made between minimizing the amount of marks made on the pattern and the size of the area that the imaging device must image.

### SUMMARY OF INVENTION

In accordance with an embodiment of the present invention there is provided a method for determining a location on a surface from an image of a region of the surface. The surface is divided into a plurality of cells arranged in a first direction and a second direction, perpendicular to the first direction. Each cell comprises a number of marks. The marks form a pattern which uniquely identifies a cell. The method comprises determining at least a part of a boundary of a first cell from locations where marks are in positions adjacent to each other. A location on the surface is determined from the pattern in the first cell.

### BRIEF DESCRIPTION OF THE DRAWINGS

In the following, embodiments of the invention will be described, by way of example only, and with reference to the drawings in which:

FIG. 1 is a block diagram showing schematically a position pointing apparatus,

FIG. 2 is a view of a pattern for disposal of a surface,

FIG. 3 is a view of a pattern for disposal of a surface showing cell boundaries,

FIG. 4 is a flow diagram showing the steps involved in a method of determining a location on a surface,

FIG. 5 is a flow diagram showing the steps involved in a method of generating a pattern for disposal on a surface,

FIG. 6 shows a cells of a pattern,

FIG. 7 shows a cells of a pattern,

FIG. 8 shows a cells of a pattern,

FIG. 9 is a flow diagram showing the steps involved in a method of generating a pattern for disposal on a surface,

FIG. 10 is a flow diagram showing the steps involved in a method of generating cells of a pattern for disposal on a surface, and

FIG. 11 is a flow diagram showing the steps involved in a method of generating cells of a pattern for disposal on a surface.

### DETAILED DESCRIPTION

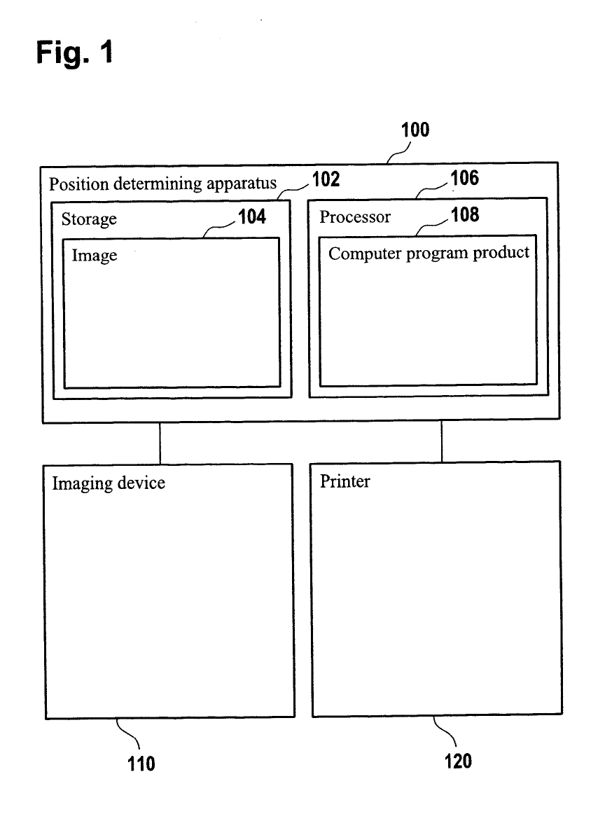

FIG. 1 illustrates a block diagram of a position determining apparatus 100. Position determining apparatus 100 comprises storage 102 and processor 106. Position determining apparatus 100 is connected to imaging device 110. Imaging device captures an image of a region of a pattern disposed on a surface. The image 104 captured by the imaging device is stored in storage 102. Image 104 is analyzed by computer program product 108 executed on processor 106, to determine a position on the surface pointed at by imaging device 110.

Position pointing apparatus 100 may be further operable to produce a pattern for disposal on a surface. This may be printer on a sheet of paper or similar by printer 120.

Position determining apparatus 100 may be a computer and imaging device 110 may be a pointing device such as a pen, mouse, or similar. Imaging device 110 may be connected to position determining apparatus by a wired or wireless connection. Alternatively position determining apparatus and imaging device may be implemented a discrete unit.

Imaging device 110 be for example a CCD or other device capable of capturing an image of a pattern disposed on a surface.

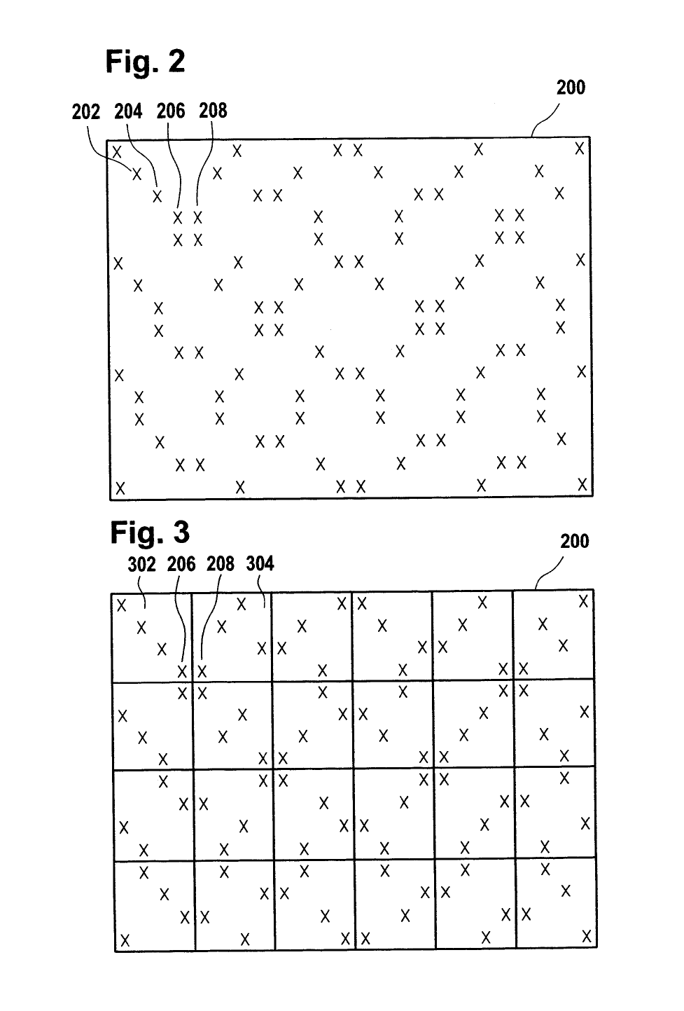

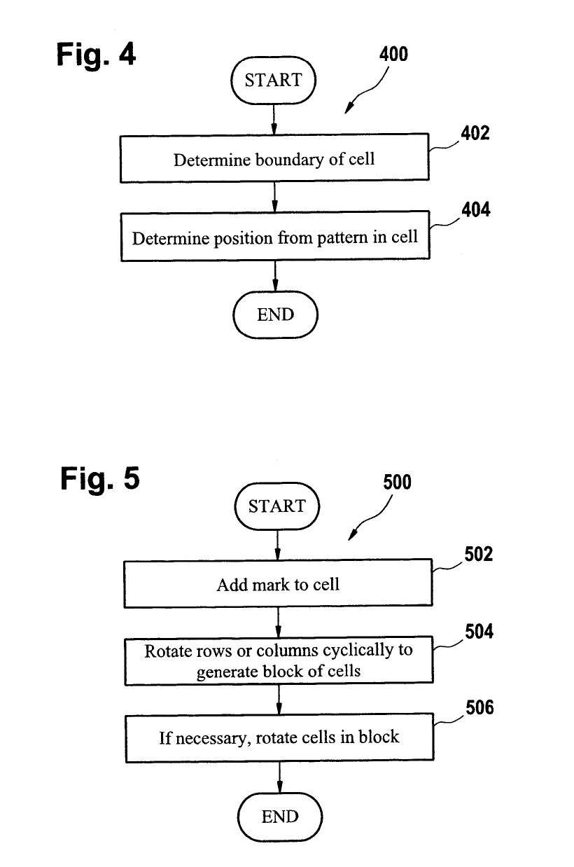

The pattern disposed on a surface will be described in more detail with reference to FIG. 2 and FIG. 3. Methods for generating such patterns and determination a position on such patterns operable on position determination apparatus 100 will be described in more detail with reference to FIGS. 4 to 11.

FIG. 2 show a surface 200 having disposed thereon a pattern of marks 202, 204, 206, 208. The pattern of marks uniquely identifies a position on surface 200. The pattern of marks is made up of a number of cells, each cell contains a unique arrangement of marks. The boundaries between cells is determined from the locations in which two marks appear adjacent to each other. Marks 206 and 208 occur adjacently to each other and therefore define a cell boundary. The pattern show in FIG. 2 has cells each containing 4 marks.

Each cell of the pattern contains one mark per row and column. This is called matrix permutation. This property makes the recognition of marks in a cell easier. It also allows the determination of cell boundaries; if two marks are adjacent, they cannot belong to the same cell as they are part of the same row or column.

FIG. 3 shows surface 200 and also shows the cell boundaries. The boundary indicated by the adjacent incidence of marks 206 and 208 is the boundary between cells 302 and 304. It is noted that while in FIG. 3 the cell boundaries are shown in use the cell boundaries do not have to be shown on the surface as they can be determined from the adjacent incidence of marks. Further, while the marks are shown as ‘X’ in the figures, in practice, the marks disposed on a surface may take any form such as dots or squares.

The cells shown in FIG. 3 each contain four marks, each cell can be thought of as having four rows and columns. Thus the cell can be referred to as being of order four. Cells of different orders can be used with methods and systems consistent with embodiments of the present invention and the order four is considered as an example here.

Surface 200 may be considered as a plane. The pattern may for example be printed on a sheet of paper and allow a location pointed to by a pointing device to be identified. It is also envisaged that surface 200 may be a document, the document may comprise a number of pages. From a region of a pattern captured by imaging device 110, the position on the page and an identifier of the page could both be determined from the pattern.

FIG. 4 shows a flowchart showing a method 400 for determining a position from an image of a region of a pattern such as that shown in FIG. 2. In step 402 the boundary of a cell in the image is determined. This determination is made from the incidence of two adjacent marks in the pattern. The boundaries may be determined from horizontally and vertically adjacent marks. Once the boundaries of a cell have been determined, the cell is analyzed to determine a location from the pattern in the cell in step 404.

FIG. 5 shows a flowchart showing a method 500 for generating a pattern for identifying a position. Method 500 may be used to produce a pattern of cells of order n from a number of cells of order n−1. In step 502, a mark is added to the cell. In step 504, columns or rows of the cell are rotated to produce further cells, thus a block of cells is generated. Once a block of cells is generated, a further block may be generated from another cell of order n−1. In order that the further block and the first block exhibit the required property that adjacent cells have one adjacent mark at the boundary it may be necessary to rotate the cell in the further block in step 506.

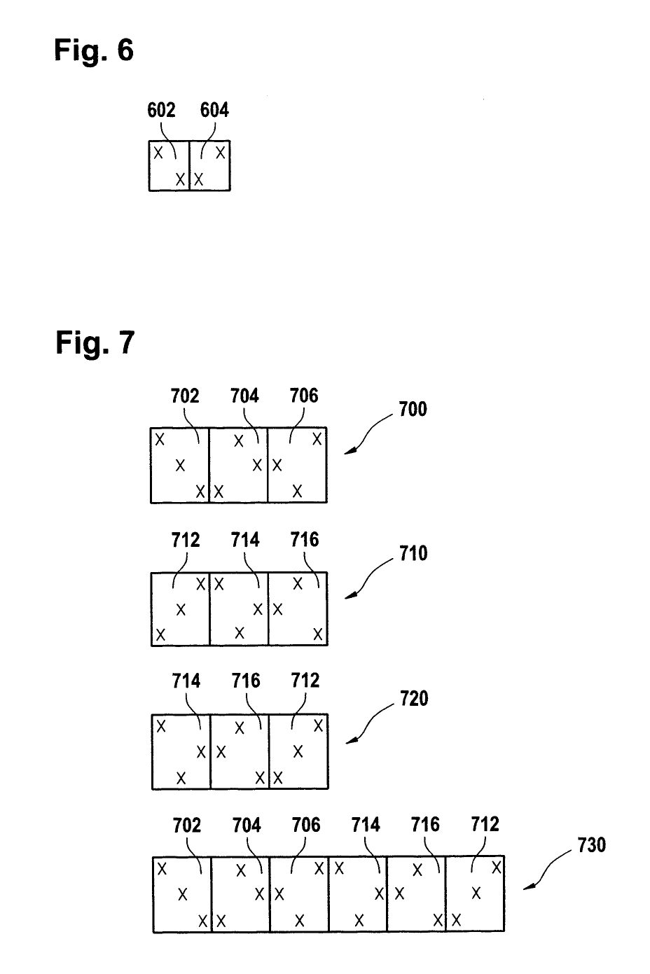

Method 500 is discussed in more detail with reference to FIGS. 6-8 below.

FIG. 6 shows two cells of order 2. These cells can be generated starting with a cell of order 1. A cell of order 1 is a single cell having a single mark. Applying method 500: a mark is added to the cell in the location (2,2) to produce cell 602. The rows are cyclically rotated horizontally to produce cell 604. The addition of a mark in position (2,2) increases the order of the cell by 1 and additionally does not break the rule of having one mark per column and row.

FIG. 7 shows the generation of 6 cells of order 3 from the two cells 602 and 604 of order 2. By applying method 500 to cell, block of cells 700 is generated as follows. Cell 702 is generated from adding a mark to the location (2,2), then cell 704 is generated by cyclically rotating the columns of cell 702 The term ‘cyclically rotating columns’ here is used to refer to the act of taking the right hand column of the cell and moving it to the left hand column of the new cell while moving the remaining columns towards the right hand side. This can also be thought of as a horizontal rotation of the marks in the rows. Cell 706 is generated by cyclically rotating the columns of cell 704. It is noted here that the act of cyclically rotating the columns of a cell to generate the next cell ensures that the required property of the pattern that adjacent cells have a boundary where adjacent marks occur is obtained.

By applying a similar process to cell 604, the block of cells 710 having cells 712, 714 and 716 is obtained. If blocks 700 and 710 are placed side by side horizontally, there will not be adjacent marks at the boundary between cell 706 and 712. Therefore the cells in block 710 are rotated cyclically until the property is obtained, this is step 506. The result of step 506 is block 720. Blocks 700 and 720 may be combined to create block 730 having the desired property that cell 706 and 714 have adjacent marks at the boundary.

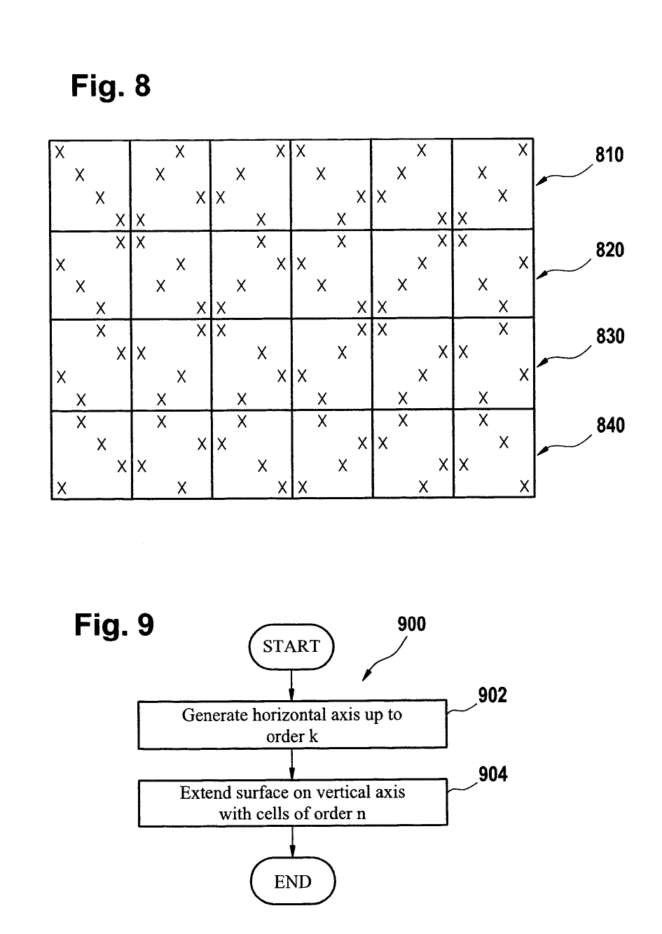

FIG. 8 shows a pattern generated by applying method 500 to block of cells 730. A mark is added in the location (2,2) to each cell of block 730 to obtain row 810. The cells of row 810 are each rotated vertically to obtain row 820. Further rotations obtain rows 830 and 840.

FIG. 9 shows a method 900 for generating a surface of k! by n!/k! cells each having n marks. In step 902, a horizontal axis of cells up to order k is generated, that is, rows of k! cells. The surface is extended vertically with cells of order n in step 904, that is, columns of n!/k! cells.

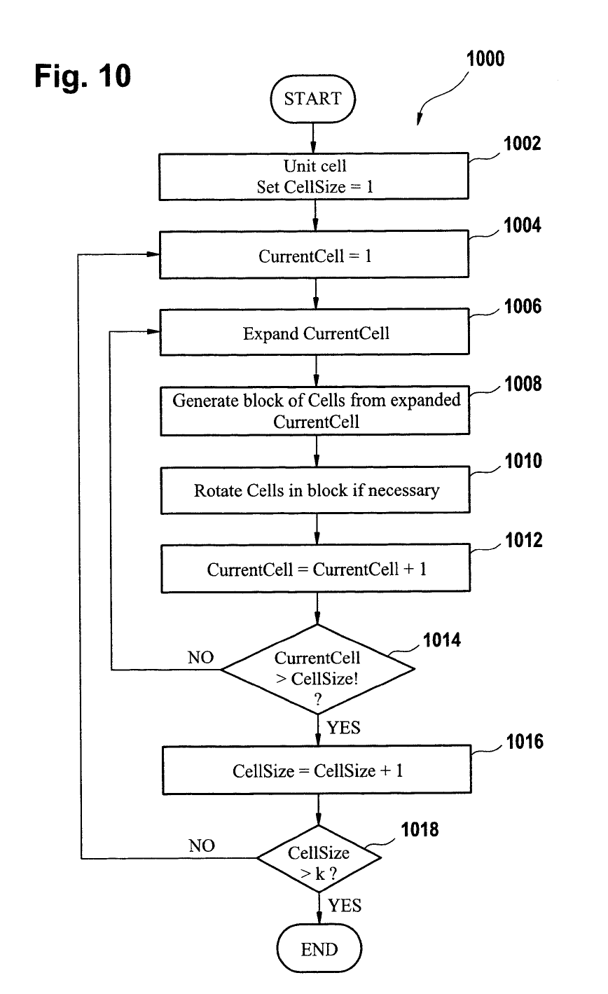

FIG. 10 shows a method 1000 of generating a horizontal row of cells of order k. Method 1000 corresponds to step 902 of method 900. The method starts in step 1002 with a unit cell. In step 1002, a variable CellSize is set to 1 as the order of the cell is one. In step 1004, the CurrentCell is set to 1. The term CurrentCell is used in the following to describe the cell being currently operated on by the method. Step 1004 corresponds to selecting the first cell in a block of cells. In step 1006, the CurrentCell is expanded. This may be by for example adding a mark to the location of the cell (2,2) as described above. Step 1006 increases the order of the cells by 1. In step 1008, a block of cells is generated from the expanded CurrentCell by applying successive horizontal cyclical rotations to the marks. In step 1010, the cells of the block of cells generated are rotated cyclically if necessary to obtain the adjacency property with the previously generated block. In step 1012 the next cell in the block of CurrentCells is selected by incrementing CurentCell. In step 1014, a determination is made whether CurrentCell is greater than CellSize factorial. The number of distinct cells of order n is n! therefore the determination in step 1014 is analogous to determining whether every CurrentCell has been expanded. In the condition ‘NO’, the method returns to step 1006 when CurrentCell is expanded. IN the condition ‘YES’, the method moves to step 1016. In step 1016, CellSize is incremented. In step 1018, a determination is made as to whether Cell Size is greater than k. In the case ‘NO’, the method returns to step 1004 and the block of cells generated are used as a source for a further expansion. In the event ‘YES’ the method ends.

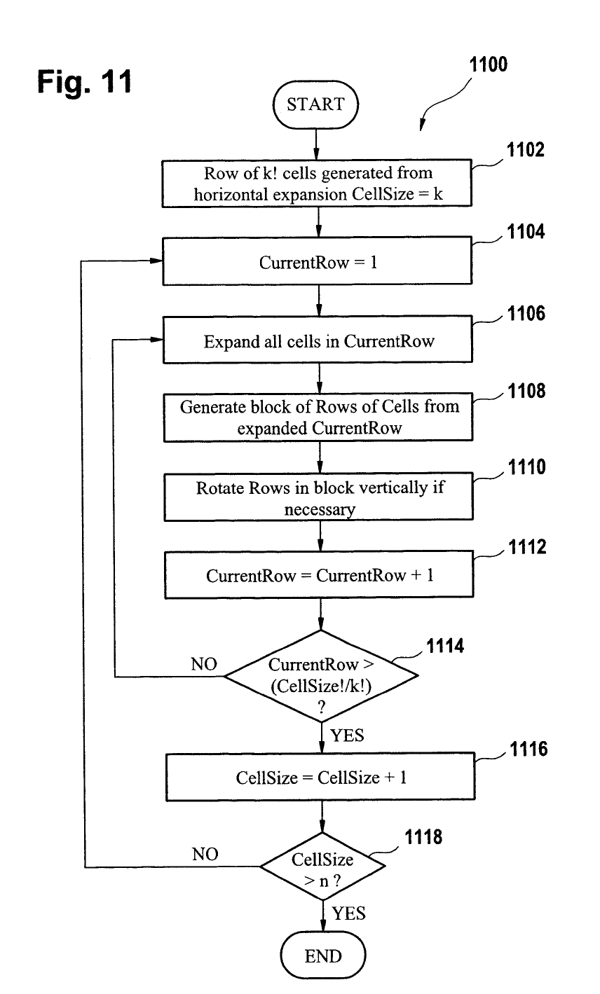

FIG. 11 shows a method 1100 for generating rows of cells from the horizontal row of cells generated in method 1000. Method 1100 corresponds to step 904 of method 900. IN step 1102, a row of k! cells generated from the horizontal expansion is taken as input. In step 1104, CurrentRow is set to 1. In step 1106, all cells in CurrentRow are expanded. Step 1106 may comprise adding a mark to the location (2,2) of all the cells in CurrentRow. In step 1108, a block of rows is generated from the expanded CurrentRow. This is realized by cyclically vertically rotating the rows of all the cells in CurrentRow to obtain a new row of cells and then performing further rotations on the resultant cells to obtain further rows of cells. In step 1110, the rows of cells obtained in step 1108 are rotated vertically if necessary to obtain the adjacency property. In step 1112, CurrentRow is incremented. In step 1114 a determination is made as to whether CurrentRow is greater than (CellSize!/k!). In the event ‘NO’, the method goes to step 1106 and further rows are expanded. In the event ‘YES’ the method moves to step 1116 and CellSize is incremented. In step 1118, a determination is made as to whether CellSize is greater than n. n is the required cell size. In the event ‘NO’ the method returns to step 1104 and the generated rows are used as inputs for a further expansion. In the event ‘YES’ the method ends.

The methods used to generate the pattern may be used in reverse to decode the pattern and determine a position. For the decoding function, pftoxy(cell, k, n), The following pseudocode may be used.

Given k as the horizontal order and n as the total order of the surface, calculate the coordinates x,y of a cell, pftoxy(cell, k, n), is a recursive procedure as follows:

```
void xypf::pftoxy( order cell, k, h){
  if( h > 1){
    if(h<=k){
      rotate horizontally the cell until dot in column 2 is on
row 2
      d = number of rotations applied
    }
    else{
      rotate horizontally the cell until dot in column 2 is on
row 2
      d = number of rotations applied
    }
    Eliminate column 2 and row 2 from the cell (this removes
one dot), so we have a new cell (h−1) dots
    pftoxy(cell, k, h−1); /* Recursive call */
    if(h<=k)
      CoordinateY = CoordinateY * h + ( d − ( h−1 − CoordinateY
% (h−1)) % (h−1) + h) % h;
    else
      CoordinateX = CoordinateX * h + ( d − ( h−1 − CoordinateX
% (h−1)) % (h−1) + h) % h;
  }
  else{
    CoordinateX = 0;
    CoordinateY = 0;
  }
}
```

If the values of k and n are known, then the location on the pattern can be obtained from the above pseudo code by determining the number of reverse rotations in the horizontal and vertical directions and reverse expansions are required to get back to a unit cell.

In order to determine a position using the above method, the pattern of one complete cell is required. This would require an imaging device able to image over an area of (2n−1) by (2n−1). Such an area would be certain to contain one complete cell. However, with knowledge of the method that was used to generate cells and the relationships between neighbouring cells it is possible to recreate areas of a partial cell and thus it may be possible to determine a position using an imaging device having a smaller field of view.

Knowledge of the expected properties of neighbouring cells could also be used to determine the orientation of a pattern. Since the rotation used to generate a second cell neighbouring a first cell is known, the relationship between the cells in the pattern can be determined.

### LIST OF REFERENCE NUMERALS

100 Position determining apparatus
102 Storage
104 Image
106 Processor
108 Computer program product
110 Imaging device
120 Printer
200 Pattern
202 Mark
204 Mark
206 Mark
208 Mark
302 Cell
304 Cell
400 Method
402 Determine boundary of cell
404 Determine position from pattern in cell
500 Method
502 Add mark to cell
504 Rotate rows or columns cyclically
506 Rotate cells in block
602 Cell
604 Cell
700 Block of cells
702 Cell
704 Cell
706 Cell
710 Block of cells
712 Cell
714 Cell
716 Cell
720 Block of cells
730 Block of cells
810 Row of cells
820 Row of cells
830 Row of cells
840 Row of cells
900 Method
902 Generate horizontal axis
904 Extend surface on vertical axis
1000 Method
1002 Set CellSize=1
1004 CurrentCell=1
1006 Expand CurrentCell
   1008 Generate block of cells from expanded CurrentCell
   1010 Rotate cells if necessary
   1012 CurrentCell=CurrentCell+1
   1014 CurrentCell>CellSize! ?
   1016 CellSize=CellSize+1
   1018 CellSize>k?
   1100 Method
   1102 Row of k! cells
   1104 CurrentRow=1
   1106 Expand all cells in CurrentRow
   1108 Generate block of rows of cells
   1110 Rotate vertically if necessary
   1112 CurrentRow=CurrentRow+1
   1114 CurrentRow>(CellSizeUk!) ?
   1116 CellSize=CellSize+1
   1118 CellSize>=n ?

1. A method (400) for determining a location on a surface (200) from an image of a region of said surface, said surface being divided into a plurality of cells (302; 304) arranged in a first direction and a second direction perpendicular to said first direction, each cell comprising a plurality of marks (202; 204; 206; 208), forming a pattern which uniquely identifies a cell, the method comprising:
determining at least part of a boundary of a first cell from locations where marks of said plurality of marks are adjacent in with said first direction or said second direction (402);
determining a location of said first cell from said pattern in said first cell (404);

2. The method of claim 1, further comprising:
determining a location within said first cell;

3. The method of claim 1, wherein the step of determining the location of said first cell comprises applying transformations to said pattern of said first cell, said transformations being transformations used to generate said pattern in a reverse order.

4. A method (500) of generating a pattern of marks (202; 204; 206; 208) for disposing on a surface (200) to uniquely identify a location on said surface from a cell of said pattern, the method comprising:
generating a first cell of said pattern (502);
generating a second cell of said pattern, said second cell having a common boundary with said first cell and one mark of said first cell being adjacent to one mark of said second cell over said common boundary.

5. The method of claim 4, further comprising cyclically rotating marks of the pattern of said first cell along a first axis to obtain the pattern of the second cell (504).

6. A position pointing apparatus (100) for determining a position from an image (104) of a region of a surface (200), said surface having a pattern of marks disposed thereon, said position pointing apparatus comprising:
Storage (102) for said image of said region of said surface;
a processor (106) operable to:
determine at least part of a boundary of a first cell of said pattern of marks, said boundary being determined from locations where two marks of said pattern of marks are adjacently disposed;
determine the location of said first cell on said surface from a pattern of marks contained within said first cell.

7. The position pointing apparatus of claim 6, the processor being further operable to produce said pattern of marks, said pattern of marks comprising a number of cells, said cells being defined by a boundary, said boundary being indicated by the incidence of two adjacent marks of said pattern of marks.

8. An article of manufacture comprising a surface (200), said surface having disposed thereon a pattern of marks (202; 204; 206; 208), said pattern of marks comprising a plurality of cells (302; 304), each cell of said plurality of cells uniquely identifying a position on said surface, each cell of said plurality of cells being defined by a boundary, said boundary being defined by the incidence of two adjacent marks of said plurality of marks.

9. The article of manufacture of claim 8, being a document, said plurality of cells uniquely identifying a position on said document.

10. A computer readable storage medium comprising data indicative of a pattern of marks (202; 204; 206; 208) for disposal on a surface (200), said pattern of marks comprising a plurality of cells (302; 304), each cell of said plurality of cells uniquely identifying a position on said surface, each cell of said plurality of cells being defined by a boundary, said boundary being defined by the incidence of two adjacent marks of said plurality of marks.
